(19) United States
(12) Patent Application Publication
(10) Pub. No.: US 2022/0250834 A1
(43) Pub. Date: Aug. 11, 2022

(54) LOCKABLE TRASH CAN

(71) Applicant: GABRIEL GREGORY GILSRUD, PRINCETON, MN (US)

(72) Inventor: GABRIEL GREGORY GILSRUD, PRINCETON, MN (US)

(21) Appl. No.: 17/665,448

(22) Filed: Feb. 4, 2022

Related U.S. Application Data
(60) Provisional application No. 63/145,983, filed on Feb. 5, 2021.

(51) Int. Cl. B65F 1/16

(52) U.S. Cl. CPC B65F 1/163; B65F 2250/11; B65F 1/1615

(57) ABSTRACT

Described herein is a lockable trash can equipped with a foot pedal, lid, and an unlock arm. This inventive concept is lockable, reusable, and durable. This inventive concept includes an upper foot pedal to control a locking system and a lower foot pedal to raise and lower the lid. An L-shaped series of connected rods is designed to allow the lockable trash can to be unlocked and opened by transferring energy applied by a user's foot to the foot pedals to the actions of the lid. In a related embodiment, a cable assembly, a latching plate and latching lever are used to simplify the unlocking of the lid by the pedal.

### CLAIM OF PRIORITY

This application claims priority to and the benefit of U.S. Provisional Application Ser. No. 63/145,983, filed on Feb. 5, 2021, with the same title, the contents of which are hereby incorporated by reference in its entirety.

### FIELD OF THE INVENTION

The inventive concept relates generally to a lockable trash can.

### BACKGROUND

Currently, there are a number of solutions for trash cans. One of these solutions attempts to utilize a waste basket, garbage bin, or standard trash can, but these solutions fail to meet market needs because they do not lock. Open tops or tops with loose lids allow easy access by animals which may pull items out of a waste basket, garbage bin, or standard trash can, or may tip these over. Waste baskets, garbage bins, or standard trash cans also may not adequately defend against curious small children or errors from adults and are unsuitable for special waste such as medical waste. Therefore, there currently exists a need in the market for an improved container for trash or other items intended for discard that prevents access to the contents within from undesired entities.

### SUMMARY OF THE INVENTION

A lockable trash can has a polymer, watertight container system with a horizontal bottom portion and at least one substantially vertical sidewall portion, a rim portion circumscribing the top portion of the vertical sidewall portion. A lid member is pivotally coupled substantially to the rim portion by a hinge assembly, the lid member designed to be in an open or closed state, when in a closed state, designed to rest substantially contiguously to an upper and side portions of the rim portion. The inventive concept includes a vertical concave channel portion of the at least one substantially vertical sidewall portion, the channel portion vertically and inwardly disposed. Right and left vertical rod members are disposed inside the vertical concave channel portion to the right and left of a center vertical rod member. A top portion of the right and left vertical rod members is pivotally and respectively coupled to a right and left lid stem member, the lid stem members correspondingly raising the lid member when raised by the vertical rod members. The center vertical rod member, when in a resting state, has an upper portion of the center vertical rod member removably disposed upward at least partially into a downwardly facing groove portion disposed on the hinge assembly of the lid assembly, designed to prevent the lid assembly from opening. A horizontal channel portion is continuous from the vertical channel portion disposed along the bottom portion of the watertight container system to create a substantially L-shaped channel assembly. A center horizontal rod member is disposed within the horizontal channel portion coupled at a distal end of the center horizontal rod member to a lower portion of the center vertical rod member and by a proximal portion of the center horizontal rod member to an upper foot pedal member to create a substantially L-shaped lid lock and release assembly. The L-shaped lid lock and release assembly is designed to be in an unlocked state when the upper foot pedal is in an active horizontally inward state, pulling the upper portion of the center vertical rod member from the downwardly facing groove portion disposed on the hinge assembly of the lid assembly, and a locked state when in a resting horizontally outward state, the upper portion of the center vertical rod member at least partially disposed back inside the downwardly facing groove portion disposed on the hinge assembly of the lid assembly. Right and left horizontal rod members are coupled at distal ends of the right and left horizontal rod members to respective bottom portions of the right and left vertical rod members and by the proximal ends of the right and left horizontal rod members to a lower foot pedal member to create a substantially L-shaped lid lift assembly pivotally coupled to a fulcrum member horizontally traversing the horizontal channel portion perpendicularly to the right and left horizontal rod members. The substantially L-shaped lid lift assembly is designed to open the lid member when the lower foot pedal member is depressed downward, the fulcrum member designed to transfer downward force applied to the lower foot pedal member to upward force directed through the right and left vertical rod members, the lid portion in a closed state when the lower foot pedal is in an upward and resting state. The upper pedal overlays the lower pedal and is designed to engage the lower pedal when the user steps down on the upper pedal.

In one embodiment of the lockable trash can, a polymer liner member circumscribes the rim portion of the at least one substantially vertical sidewall portion.

In one embodiment of the lockable trash can, the polymer, watertight container system is substantially cylindrical.

It would be advantageous to have a lockable trash can that is reusable. Furthermore, it would be advantageous to have a lockable trash can that is lockable.

The inventive concept advantageously fills the aforementioned deficiencies by providing a lockable trashcan, which provides a spill-proof way to dispose of trash.

The lockable trash can may have a single foot pedal to unlock and open the lid.

The lockable trash can has a lockable lid which can use various locking mechanisms including but not limited to a pin and hole assembly; a slot and blade arrangement; a nub and indent in the form of a friction fit; a hook and loop fastener arrangement; a magnetic arrangement and a block and tackle arrangement.

The lockable trash can fulfills the need for a spill-proof trash can.

Among other things, it is an advantage of a lockable trash can to provide a lockable trash can that does not suffer from problems or deficiencies associated with prior solutions.

It is still further an advantage of the lockable trash can to be reusable.

Still further, the lockable trash can is formed from a durable polymer material. However, in other embodiments, the body and lid of the trash can is formed from metal or can have a combination of metallic and polymer (or plastic) parts.

This inventive concept is lockable, reusable, and durable. This inventive concept includes an upper foot pedal to control a locking system and a lower foot pedal to raise and lower the lid. An L-shaped series of connected rods is designed to allow the lockable trash can to be unlocked and opened by transferring energy applied by a user's foot to the foot pedals to the actions of the lid.

The inventive concept now will be described more fully hereinafter with reference to the accompanying drawings, which are intended to be read in conjunction with both this summary, the detailed description and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates the front view of the lockable trash can.

FIG. 2 illustrates the back view of the lockable trash can.

FIG. 3 illustrates the side view of the lockable trash can.

FIG. 4 illustrates the bottom view of the lockable trash can with part of the locking mechanism.

FIG. 5 illustrates a perspective view of the lockable trash can with the lid open.

FIG. 6 illustrates an interior view of the locking assembly of the trash can.

FIGS. 7A-7B illustrate bottom and interior views of the lock and lift assemblies.

FIG. 8 illustrates a frame member for securing a liner within the trash can.

FIGS. 9A-9B illustrate perspective views, respectively, another embodiment of a locking mechanism for a trash can.

FIGS. 10A-10B illustrate views of the lid coupled to a cable for engaging a trash can lid and a latching device for coupling to a pedal of the trash can, respectively.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

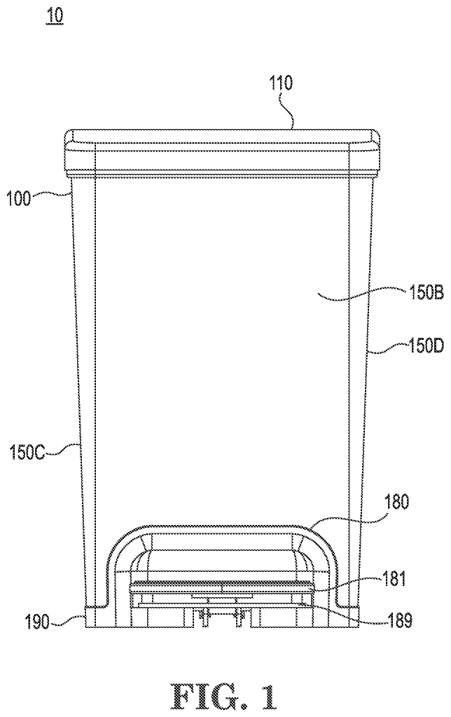

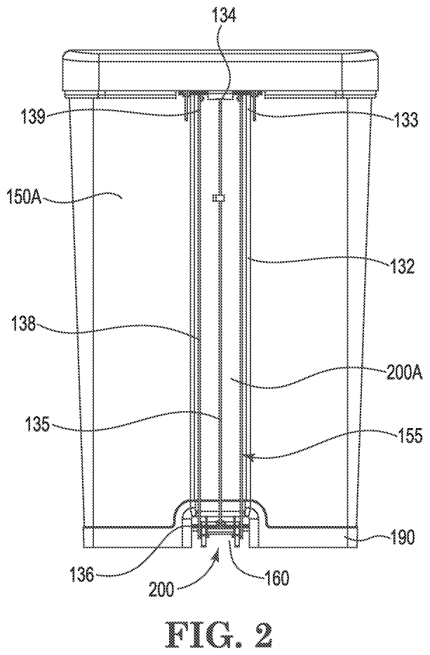

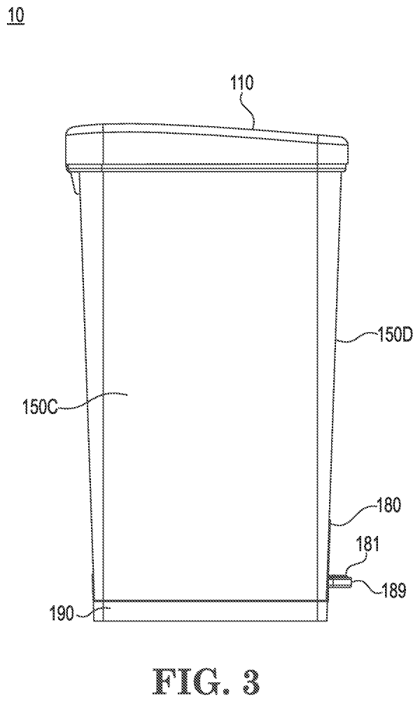

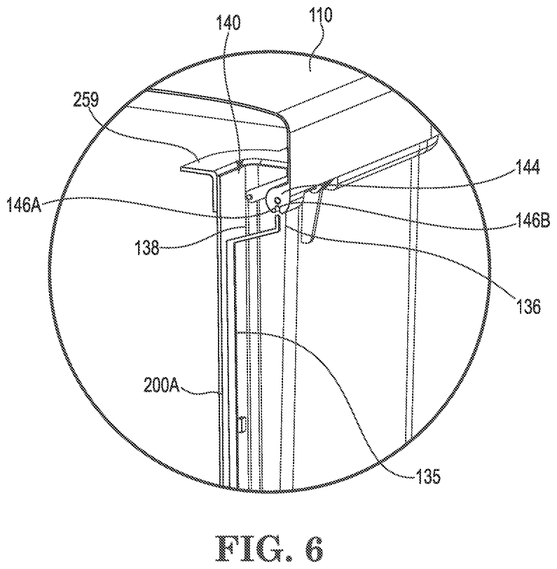

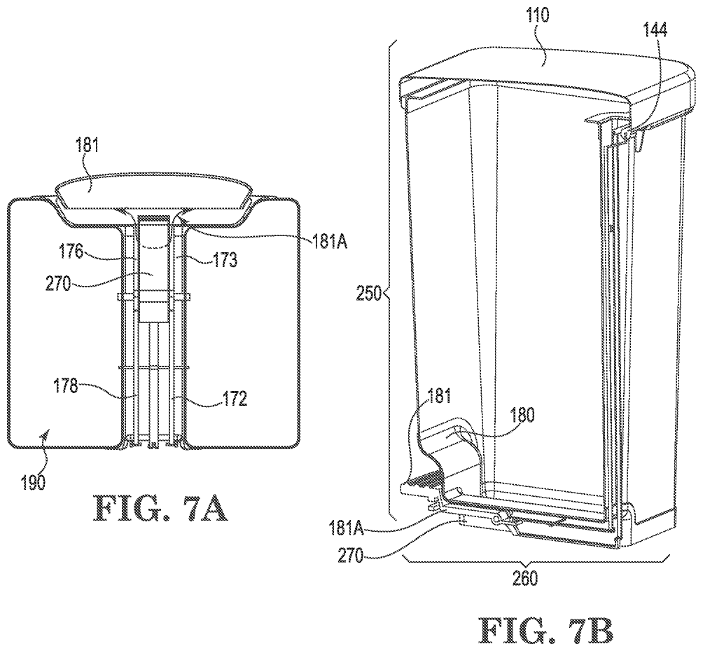

Referring to the figures, FIGS. 1-8 illustrate in this embodiment a lockable trash can 10 that has a polymer, watertight container system 100 formed from a body 150 and a lid member 110, a horizontal bottom portion 190 and an optional liner member 300. Body 150 is formed from a vertical rear sidewall portion 150A, a front vertical sidewall portion 150B and two end wall portions 150C and 150D, respectively. In this example embodiment, front sidewall 150B includes a foot pedal well or opening 180 for foot pedals 181 and 189, depending on the desired foot pedal design. In this example embodiment, pedal 181 unlocks lid 110 and pedal 189 opens lid 110 when they are depressed (or pushed downwardly) individually. Can 10 further includes a rim portion 159 circumscribing an upper top portion of body 150 and vertical portions 150A-150D. Lid member 110 is pivotally coupled substantially to the rim portion 159 by a hinge assembly 140 (see FIG. 7), lid member 110 being designed to be in an open or closed state. When in a closed state, lid member 110 is designed to rest substantially contiguously to an upper portion of the rim portion 159 and side portions 157 of the rim portion 159.

In this example embodiment, watertight container 100 includes a vertical concave channel portion 155 of the at least one substantially vertical rear sidewall portion 150A, the channel portion 155 vertically and inwardly disposed. A right vertical rod member 132 and a left vertical rod member 138 are disposed inside the vertical concave channel portion 155 to the right and left of a center vertical rod member 135. A top portion 133 of the right vertical rod member 132 and a top portion 139 of a left vertical rod member 138 is pivotally and respectively coupled to a right lid stem member 142 and left lid stem member 148, the lid stem members 142, 148 correspondingly raising the lid member 110 when raised by the vertical rod members 132, 138 (upon depressing pedal 189). The center vertical rod member 135, when in a resting state, has an upper portion or plate 134 of the center vertical rod member 135 that is removably disposed upward at least partially into a downwardly facing groove portion 146A disposed on a hinge roller 144 of hinge assembly 140 of the lid 110. While plate 134 is engaged with groove 146A such is designed to prevent the lid assembly 110 from opening. In another embodiment, hinge roller 144 includes groove 146B to maintain lid 110 in an open position.

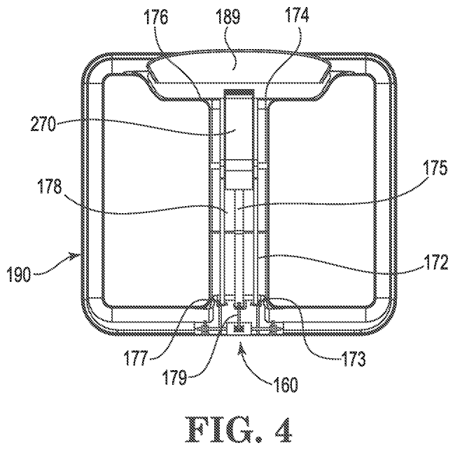

Referring more closely to FIG. 4, a horizontal channel portion 160 is continuous from the vertical channel portion 155 disposed along the bottom portion 190 of the watertight container 100 to create a substantially L-shaped channel assembly 200, formed from a vertical channel portion 200A and a horizontal channel portion 160. A center horizontal rod member 175 is disposed within the horizontal channel portion 160 coupled at a distal end 179 of the center horizontal rod member 175 to a lower portion 136 of the center vertical rod member 135 and by a proximal plate or portion 171 of the center horizontal rod member 175 to an upper foot pedal member 181 to create a substantially L-shaped lid lock and release assembly 250.

Referring more closely to FIGS. 1-3 and 7A-7B, there is illustrated an L-shaped lid lock and release assembly 250 that is designed to be in an unlocked state when the upper foot pedal 181 (and pedal extension 181A) is in an active horizontally inward (depressed) state, pulling the upper portion 136 of the center vertical rod member 135 from the downwardly facing groove portion 146A disposed on a hinge assembly roller 144 adjacent lid 110, and a locked state when in a resting horizontally outward state, the upper portion 134 of the center vertical rod member 135 at least partially disposed back inside the downwardly facing groove portion 146A of roller 144. Roller 144 optionally includes second groove 146B which can engage 136 to keep lid 110 open if desired. Pushing down pedal 189 then engages rod members 132 and 138, via respective rod members 173 and 177 at the bottom which are coupled to pedal 189, to open lid 110 by pushing up at ends 142 and 148.

Referring to plate 190, a right horizontal rod member 172 and a left horizontal rod member 178 are coupled at respective distal ends to respective bottom portions of the right and left vertical rod members 132, 138. A proximal end 176 of the right horizontal rod member 177 and a proximal end 173 of the left horizontal rod member 178 are coupled to lower foot pedal member 189 to create a substantially a lower L-shaped lid lift assembly 260 (forming part of lift assembly 250) while pedal 181 and extension 181A are pivotally coupled to a fulcrum member 270 horizontally traversing the horizontal channel portion 160 perpendicularly to the right horizontal rod members 172 and left horizontal rod members 178. The substantially L-shaped lid lift assembly 260 is designed to open the lid member 110 when the lower foot pedal member 189 is depressed downward. Upon depressing pedal 189 or fully depressing pedal 181 to the ground, fulcrum member 270 is designed to transfer the downward force applied to it and become an upward force directed through the right and left vertical rod members 132, 138, thereby opening lid 110. Lid portion 110 in a closed state when the lower foot pedal 189 is in an upward and resting state. The upper pedal 181 overlays the lower pedal 189 and is designed to engage the lower pedal 189 when the user steps all the way down on the upper pedal 181.

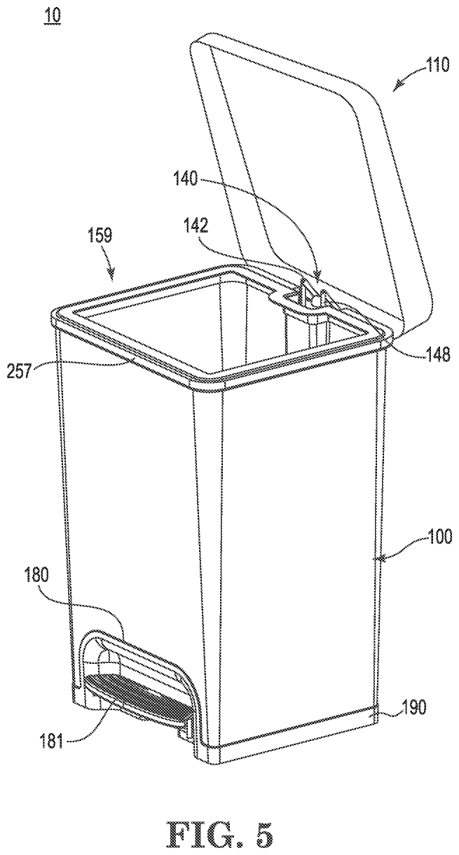

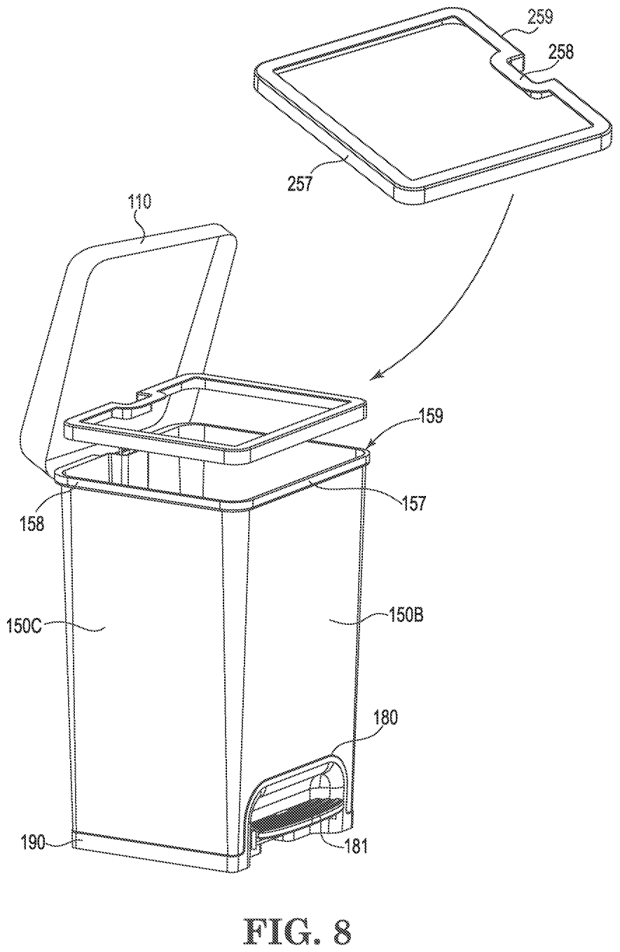

Referring to FIGS. 5 and 8, in one embodiment of the lockable trash can 10, an polymer liner member 259 circumscribes the rim portion 159 of the vertical sidewall endwall portions 150A-150D and includes a frame 257 with a cutout portion 258 that rests on rim portion 159 and about hinge assembly 140 and vertical channel 200A. In this example embodiment, liner member 259 facilitates the use of plastic or polymer garbage bag within body 150 and creates and internal lip or ridge around rim 159 to prevent fluids from spilling out of body 150 when can 10 is tipped or inadvertently knocked over, whether lid member 110 is closed/locked or open.

In one example embodiment of the lockable trash can, the watertight container system 100 is substantially cylindrical and can be made from other materials other than polymer, such as stainless steel or aluminum. Liner member 259 can also be made of other materials and can be replaced with a complete internal liner receptacle in other embodiments.

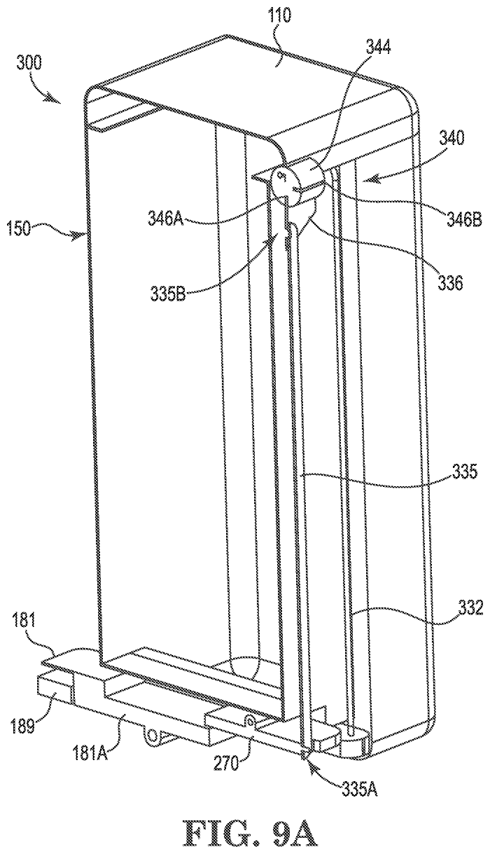

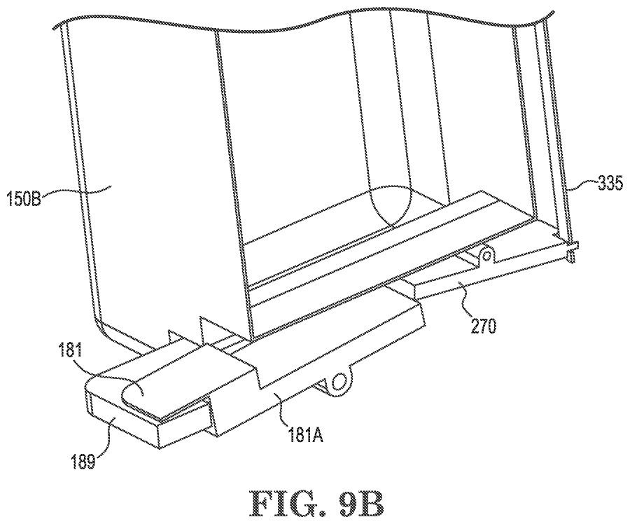

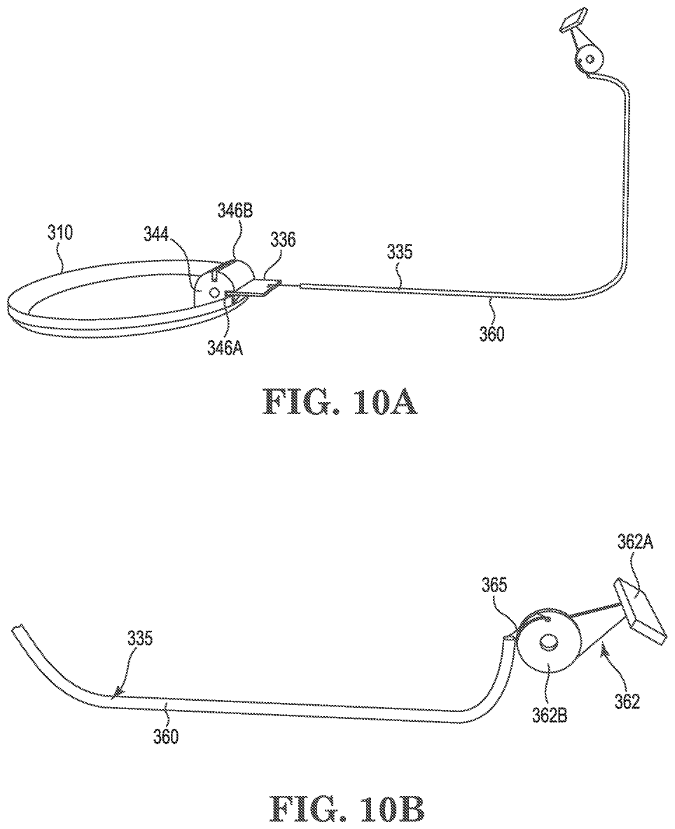

Referring now to another embodiment, FIGS. 9A-9B illustrate perspective views, respectively, another embodiment of a locking mechanism for a trash can 300. Where similar elements from previous embodiments applied, the same numerals will be used for ease of description and comprehension of inventive concept. Further, FIGS. 10A-10B illustrate views of a lid 310 coupled to a cable assembly 335 for engaging trash can lid 310 and a latching device or assembly 340 and coupling to a pedal of the trash can, respectively. In this example embodiment, a cable and wire latching assembly 340 is used to open/close lid 110 and 310 (if circular body is used for body 150 of watertight container 100) and to lock/unlock same. Latching assembly 340 includes a roller 344 with two grooves 346A and 346B thereon for used in locking and unlocking can 300 and/or maintaining lids 110/310 in an open position as desired by user. Latching assembly 340 which includes a cable 335 is coupled at one end 335A to fulcrum plate 270 and at another end 335B to roller 344 via a movable latching plate 336 coupled to cable 335. As user depresses pedal 181, pedal extension 181A pushes up fulcrum 270 thereby pulling down cable 335 at end 335A and pulling down plate 336 at end 335B to release or unlock lid 110/310.

In this embodiment, latching assembly 340 is either coupled to the lid or includes a spring that turns roller 344 to groove 346B so that plate 336 engages groove 346B to keep lid 110/330 open. Once user wants to close the lid, depressing pedals 181 and 189 pulls cable 335 and latching plate 336 out of groove 346B and user can manually let the lid close.

Similarly, FIGS. 10A and 10B illustrate a lid 330 coupled to latching assembly 340. In particular, latching assembly 340 includes cable 335 having a cable housing 360 and a wire 365 housed therein that is coupled to plate 336 at one end and to a latching lever 362. Latching lever 362 is operatively coupled to fulcrum 270 and to pedal 181 to facilitate movement of plate 336 away from groove 346A when opening the lid. As lever 362A is engaged, wire 365 is pulled thereby pulling plate 336 via a circular plate 362B on lever 362. This embodiment lowers manufacturing costs as it simplifies the design and reduces the number of parts for manufacturing.

The following patents are incorporated by reference in their entireties: U.S. Pat. Nos. 8,136,688, 8,297,470 and 9,481,515.

While the inventive concept has been described above in terms of specific embodiments, it is to be understood that the inventive concept is not limited to these disclosed embodiments. Upon reading the teachings of this disclosure many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. A lockable trash can comprising:
a watertight container assembly with a lid and a housing having a horizontal bottom portion, the housing having a front and a rear vertical sidewall portions and two endwall portions, the housing having a rim portion circumscribing a top portion of the housing and the sidewall and endwall portions;
a vertical concave channel portion disposed on the rear vertical sidewall portion, the concave channel portion vertically and inwardly disposed;
right and left vertical rod members disposed inside the vertical concave channel portion to the right and left of a center vertical rod member, a top portion of the right and left vertical rod members pivotally and respectively coupled to a right and left lid stem member, the lid stem members correspondingly raising the lid member when raised by the vertical rod members;
a horizontal channel portion continuous from the vertical channel portion disposed along the bottom portion of the watertight container assembly to create a substantially L-shaped channel assembly;
a center horizontal rod member disposed within the horizontal channel portion coupled at a distal end of the center horizontal rod member to a lower portion of the center vertical rod member and by a proximal portion of the center horizontal rod member to an upper foot pedal member to create a substantially L-shaped lid lock and release assembly adapted to be in an unlocked state when the upper foot pedal is in an active horizontally inward state, pulling the upper portion of the center vertical rod member from the downwardly facing groove portion disposed on the hinge assembly of the lid assembly, and a locked state when in a resting horizontally outward state, the upper portion of the center vertical rod member at least partially disposed back inside the downwardly facing groove portion disposed on the hinge assembly of the lid assembly;
right and left horizontal rod members coupled at distal ends of the right and left horizontal rod members to respective bottom portions of the right and left vertical rod members and by the proximal ends of the right and left horizontal rod members to a lower foot pedal member to create a substantially L-shaped lid lift assembly pivotally coupled to a fulcrum member horizontally traversing the horizontal channel portion perpendicularly to the right and left horizontal rod members;
the substantially L-shaped lid lift assembly adapted to open the lid member when the lower foot pedal member is depressed downward, the fulcrum member adapted to transfer downward force applied to the lower foot pedal member to upward force directed through the right and left vertical rod members, the lid portion in a closed state when the lower foot pedal is in an upward and resting state; and
the upper pedal overlaying the lower pedal and adapted to engage the lower pedal when the user steps down on the upper pedal.

2. The lockable trash can of claim 1 wherein a liner member circumscribes the rim portion of the housing sidewall and endwall portions.

3. The lockable trash can of claim 1 wherein the watertight container system is substantially cylindrical.

4. The trash can of claim 2 wherein the watertight container assembly and the liner member are formed from a polymer.

5. The trash can of claim 1 wherein the lid member is pivotally coupled substantially to the rim portion by a hinge assembly, the lid member adapted to be in an open or closed state, when in a closed state the lid member adapted to rest substantially contiguously on rim portion.

6. The trash can of claim 5 wherein the center vertical rod member, when in a resting state, has an upper portion of the center vertical rod member removably disposed within a downwardly facing groove portion disposed on a roller member forming part of the hinge assembly, engagement with downwardly facing groove adapted to prevent the lid assembly from opening.

7. The trash can of claim 2 wherein the watertight container and the liner member are formed from metal.

8. The trash can of claim 1 wherein the lid member is unlocked upon partially depressing the upper pedal member, thereby allowing user to manually open the lid.

9. The trash can of claim 2 wherein the liner member has an interior circumference smaller than the rim portion of the housing adapted to prevent fluid materials from exiting the housing upon the watertight container being tipped over.

10. The trash can of claim 6, wherein the roller member includes a second groove adapted for locking the lid in an open position.

11. A lockable trash can assembly having a housing with a lid coupled to an open end of the housing, the housing including a lid opening assembly operated by downwardly depressing at least one pedal member, the trash can assembly comprising:
a latching assembly located on an outside surface of the housing, the latching assembly coupled at one end with the at least one pedal and at an opposite end at the lid and the open end of the housing;
wherein the latching assembly includes a hinge assembly, a cable assembly, a cylindrical roller member and a latching lever, the hinge assembly being coupled to both the lid and the housing at the open end;
wherein the cable assembly includes at first end a latching plate adapted to be in contact with a first groove of the cylindrical roller member to lock the lid into a closed state; and
the latching lever coupled to a second end of the cable assembly and to the at least one pedal member.

12. The trash can of claim 11 wherein the cable assembly includes an internal wire member coupled at a proximal end to the latching plate and coupled at a distal end to the latching lever.

13. The trash can of claim 11 wherein the roller member includes a second groove on the roller member surface adapted for locking the lid in an open position when the latching plate is engaged with the second groove.

14. The trash can of claim 12 wherein the latching lever includes a circular wheel at one end coupled to the wire assembly to facilitate pulling of the latching plate when the at least one pedal member is depressed.

15. The trash can of claim 11 further comprising a second pedal member adjacent to the first pedal member and adapted to raise the lid after unlocking.

16. The trash can of claim 11 further comprising a liner member adapted to circumscribe the housing opening, the liner member having an interior circumference smaller than a rim or housing opening and adapted to prevent fluid materials from exiting the housing upon the watertight container being tipped over.

17. The trash can of claim 11 further comprising a fulcrum member in operative contact with the at least one pedal member and with the cable assembly.

18. The trash can of claim 11 wherein the housing and lid are made of a material selected from the group consisting of a polymer, a metal and aluminum.
